(19) United States
(12) Patent Application Publication
(10) Pub. No.: US 2026/0292694 A1
(43) Pub. Date: Sep. 24, 2026

(54) LOW POWER WAKE-UP SIGNAL, LOW POWER WAKE-UP RECEIVER, AND PAGING MONITORING FOR IDLE OR INACTIVE USER EQUIPMENT

(71) Applicant: Apple Inc., Cupertino, CA (US)

(72) Inventors: Sigen Ye, Whitehouse Station, NJ (US); Oghenekome Oteri, San Diego, CA (US); Wei Zeng, Saratoga, CA (US); Weidong Yang, San Diego, CA (US); Chunxuan Ye, San Diego, CA (US); Dawei Zhang, Saratoga, CA (US)

(21) Appl. No.: 19/472,597

(22) PCT Filed: Mar. 4, 2024
(86) PCT No.: PCT/US2024/018429

§ 371 Date: Oct. 3, 2025

Related U.S. Application Data
(60) Provisional application No. 63/457,683, filed on Apr. 6, 2023.

(51) Int. Cl. H04W 52/02; H04W 68/02; H04W 72/23; H04W 76/28

(52) U.S. Cl. CPC H04W 52/0235; H04W 68/02; H04W 72/23; H04W 76/28

(57) ABSTRACT

A user equipment (UE) includes a transceiver, a wake-up receiver (WUR) operable at a lower power than the transceiver, and a processor. The processor is configured to determine a timing of a wake-up signal (WUS) monitoring occasion, the timing based at least in part on a periodicity anchored to a timing reference, and on an offset based on the timing reference or the periodicity; monitor for a WUS using the WUR during the WUS monitoring occasion; and transition the transceiver from a sleep state to an awake state upon detecting the WUS during the WUS monitoring occasion.

### CROSS-REFERENCE TO RELATED APPLICATION

This Patent Cooperation Treaty patent application claims priority to U.S. Provisional Patent Application No. 63/457,683, filed Apr. 6, 2023, and titled “Low Power Wake-Up Signal, Low Power Wake-Up Receiver, and Paging Monitoring for Idle or Inactive User Equipment,” the contents of which are incorporated herein by reference in its entirety.

### TECHNICAL FIELD

This application relates generally to wireless communication systems, including systems in which a user equipment (UE) uses a low power (LP) wake-up receiver (WUR) to monitor for a LP wake-up signal (WUS) transmitted by a network device, and monitors for paging information after receiving the LP WUS and transitioning a transceiver (or receiver) of the UE from a sleep state to an awake state.

### BACKGROUND

Wireless mobile communication technology uses various standards and protocols to transmit data between a network device (e.g., a base station, a radio head, etc.) and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 shows an example method of wireless communication by a UE, according to embodiments described herein.

FIGS. 3-9 show various timelines for transmitting/receiving a WUS, according to embodiments described herein.

FIGS. 10-12 show various timelines for transmitting/receiving a WUS, and for monitoring a physical downlink control channel (PDCCH), according to embodiments described herein.

FIG. 13 shows another example method of wireless communication by a network device, according to embodiments described herein.

FIG. 14 illustrates an example architecture of a wireless communication system, according to embodiments described herein.

FIG. 15 illustrates an example system for performing signaling between a wireless device and a network device, according to embodiments described herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

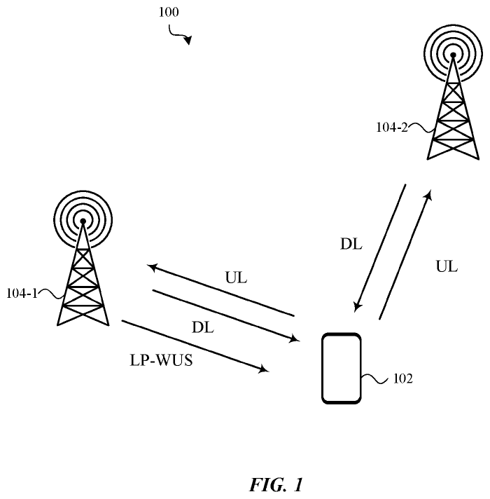

FIG. 1 shows an example wireless communications system 100. The wireless communications system may include a UE 102 that is connected, over the air, to a network (e.g., a 3GPP network). The UE 102 may communicate with the network on one or more uplink (UL) channels and one or more downlink (DL) channels, and more particularly may communicate with one or more network devices of a RAN (e.g., network devices 104-1 and 104-2, which may take the form of one or more base stations, remote radio heads, etc.) on the one or more UL channels and DL channels. Depending on the capabilities of the UE 102 and the UE's configuration by the network, the UE 102 may communicate with the one or more network devices 104-1, 104-2 simultaneously, contemporaneously (e.g., in a multiple input multiple output (MIMO) mode), or sequentially (e.g., when handed over).

In some cases, the UE 102 may be connected to a network device 104-1 in a radio resource control (RRC) idle mode state or an RRC inactive mode state.

In some embodiments, the UE 102 may have a main radio (or transceiver) that can be used for RRM purposes and data/control reception/transmission, and a LP-WUR that is operable at a much lower power level than the main radio (e.g., in some cases, an order of magnitude or two less power than the main radio). The LP-WUR may support limited functionality, such as the monitoring/detection of a LP-WUS when the UE 102 is in an RRC idle mode state or an RRC inactive mode state with respect to a network device. Upon detecting a LP-WUS using the LP-WUR, the UE 102 may wake its main radio. Of note, the LP-WUR may be a logical entity of the UE, and may or may not correspond to an entity that is physically separate from the main radio (or transceiver).

Although it has been discussed in 3GPP working groups that a UE may wake its main radio upon detecting a LP-WUS at its LP-WUR, there has, to date, been little discussion regarding how or when a LP-WUR monitors for a LP-WUS-especially when a network device transmits on multiple transmit (Tx) beams. There has also been limited discussion on how the wakeup of a main receiver, in response to the detection of a LP-WUS by a LP-WUR, affects paging procedures.

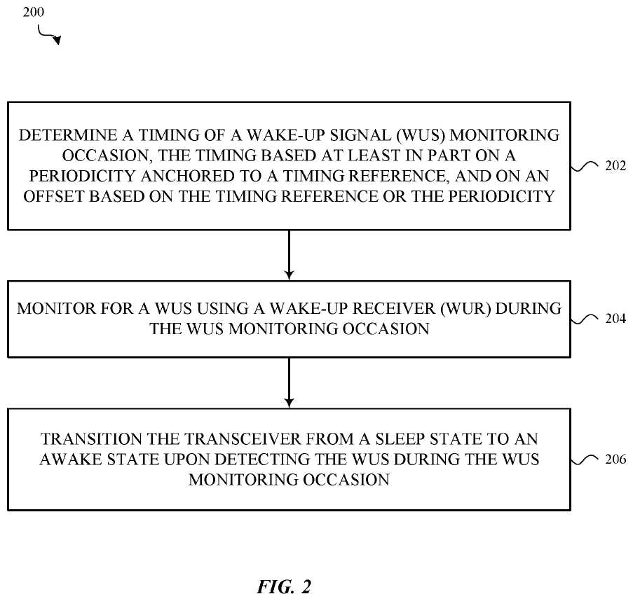

FIG. 2 shows an example method 200 of wireless communication by a UE. In some cases, the UE may be the UE described with reference to FIG. 1 or one of the other UEs described herein. The method 200 may be performed using a processor, a transceiver (or receiver), a WUR (e. g, a LP WUR), or other components of the UE.

At 202, the method 200 may include determining a timing of a WUS monitoring occasion. Depending on implementation, the WUS monitoring occasion may be a window within which a WUS may be transmitted, or a time during which a WUS may be transmitted. The timing may be based at least in part on a periodicity anchored to a timing reference (e.g., a WUS monitoring cycle periodicity), and on an offset based on the timing reference or the periodicity. Each of the timing reference, periodicity, and offset may be pre-defined (e.g., in a 3GPP technical specification (TS), or standard) or configured (e.g., received from a network device, such as a network device of a RAN, such as a base station (e.g., a gNB)). The timing reference, periodicity, and offset may be configured by one or more indications provided, for example, in one or more information element (IEs), or in one or more fields of an IE. In some embodiments, the indications may be provided in broadcast signaling (e.g., in a system information block (SIB)). In some embodiments, the indications may be provided in UE-specific signaling (e.g., before an RRC connection is released). The indications may also be provided in other ways. For purposes of this description, all data items that may be configured or pre-defined as described in this paragraph.

At 204, the method 200 may include monitoring for a WUS (e.g., a LP WUS), using the WUR, during the WUS monitoring occasion.

At 206, the method 200 may include transitioning the transceiver (or receiver) from a sleep state to an awake state upon detecting the WUS during the WUS monitoring occasion. The sleep state of the transceiver (or receiver) may be a lower power state than an awake or normal operating state. In some embodiments, the lower power state may be an OFF state.

The method 200 may be variously embodied, extended, or adapted, as described in the following paragraphs and elsewhere in this description.

In some embodiments, the method 200 may include transitioning the WUR to a sleep state during one or more times outside the WUS monitoring occasion (e.g., the WUR may be operated in a periodic or aperiodic discontinuous reception (DRX) mode). The sleep state of the WUR may be a lower power state than an awake or normal operating state of the WUR. In some embodiments, the lower power state may be an OFF state.

In some embodiments of the method 200, the WUS may be transmitted by a network device (e.g., a network device of a RAN, such as a base station) on a single beam (i.e., in a single beamformed transmission). The WUS may be transmitted within a single WUS monitoring occasion within a period defined by the WUS monitoring cycle periodicity, or the WUS may be transmitted multiple times within the period defined by the WUS monitoring cycle periodicity, using one or multiple WUS monitoring occasions. When a network device can transmit the WUS any number of times, or using any number of WUS monitoring occasions, within the period defined by the WUS monitoring cycle periodicity, the number of WUS transmissions or number of WUS monitoring occasions may be configured or pre-defined.

When there are multiple WUS monitoring occasions, and in some embodiments, the method 200 may further include determining a number of multiple WUS monitoring occasions in a set of multiple WUS monitoring occasions. The set of multiple WUS monitoring occasions may include the WUS monitoring occasion referenced at 202. The method 200 may also include determining a timing gap between temporally sequential (or adjacent, but possibly spaced apart) WUS monitoring occasions of the set of multiple WUS monitoring occasions; determining a set of timings of the set of multiple WUS monitoring occasions; and monitoring for the WUS using the WUR during each WUS monitoring occasion of the set of multiple WUS monitoring occasions. The set of timings may be determined based at least in part on the periodicity, the offset, and the timing gap. The method 200 may further include transitioning the WUR to the sleep state between adjacent WUS monitoring occasions. As an example, FIG. 3 shows a timeline 300 for transmitting/receiving a WUS 302 in one or more of a set of WUS monitoring occasions 304, 306, 308, 310 associated with a periodicity 312, an offset 314 from the start of a period defined by the periodicity 312, and a timing gap 316. The timing gap 316 between different pairs of adjacent WUS monitoring occasions may be the same (as shown) or different.

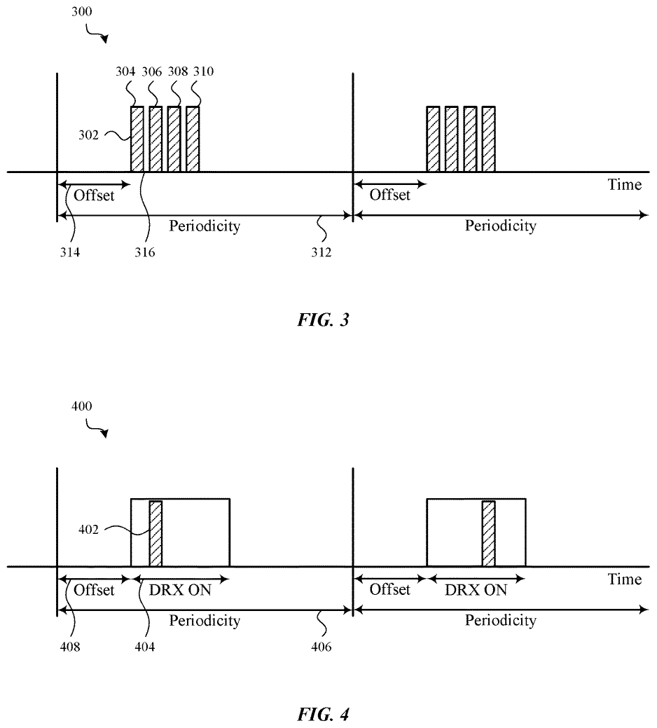

When there are multiple WUS monitoring occasions, and in some embodiments, the method 200 may further include identifying a DRX ON duration and determining a duration of the WUS monitoring occasion based at least in part on the DRX ON duration. In these embodiments, a network device may transmit the WUS one or multiple times within the DRX ON duration, and the UE may detect the WUS one or multiple times. The network device need not indicate when or how many times the WUS may be transmitted within the DRX ON duration, thus providing the network some flexibility on when to transmit the WUS. The DRX ON duration may be configured or pre-defined. As an example, FIG. 4 shows a timeline 400 for transmitting/receiving a WUS 402 during a DRX ON duration 404 associated with a periodicity 406 and an offset 408 from the start of a period defined by the periodicity 406.

In some embodiments of the method 200, the WUS may be transmitted by a network device (e.g., a network device of a RAN, such as a base station) on one or multiple Tx beams (e.g., in multiple beamformed transmissions). For a network device that is capable of transmitting on multiple beams, with synchronization signal block (SSB) transmissions on each beam, the WUS may need to be transmitted on each of the multiple beams to provide good WUS coverage. A UE, however, may only monitor for the WUS using a single receive (Rx) beam, to maintain low power operation and/or to receive the WUS with low complexity hardware.

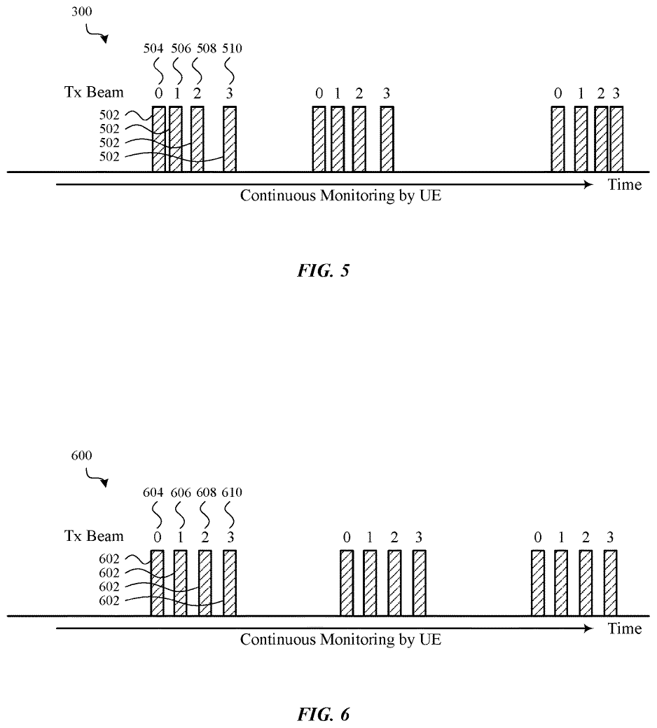

For a UE that monitors for a WUS continuously, a network device may not need to pre-configure (or indicate) the time resources that will be used to transmit the WUS on different beams, because the UE only monitors for the WUS using a single Rx beam and is always monitoring for the WUS. Such a UE may be able to receive the WUS on more than one Tx beam. From the network device perspective, the network device has some flexibility in terms of when to transmit the WUS and when to transmit the WUS on different beams (including the order of the transmissions on different Tx beams), as long as any latency requirements are satisfied. As an example, FIG. 5 shows a timeline 500 for transmitting/receiving a WUS 502 on one or more of a set of multiple Tx beams 504, 506, 508, 510 (e.g., Beam 0, 1, 2, and 3). As shown, the WUS 502 may be transmitted on different Tx beams 504, 506, 508, 510 at irregular times. Alternatively, the WUS 502 may be transmitted on each Tx beams 504, 506, 508, 510 in accordance with a periodicity.

For a UE that monitors for a WUS at discrete times (e.g., in accordance with a periodicity and one or more WUS monitoring occasions and/or a DRX ON duration), a network device may need to configure (and indicate) the time resources that will be used to transmit the WUS, or the time resources on which the WUS will be transmitted need to be pre-defined. FIG. 6 shows a somewhat generic timeline 600 for transmitting/receiving a WUS 602 on one or more of a set of multiple Tx beams 604, 606, 608, 610. A UE that monitors for a WUS at discrete times needs to know when it should monitor for the WUS. Various options for indicating or defining when a UE should monitor for a WUS are described with reference to FIG. 2 and FIGS. 7-9

In some cases, the method 200 may include identifying a DRX ON duration and determining a duration of the WUS monitoring occasion based at least in part on the DRX ON duration. In these embodiments, a network device may transmit the WUS one or multiple times, on one or multiple beams, within the DRX ON duration, and the UE may detect the WUS one or multiple times, on one or multiple beams. The network device need not indicate when or how many times the WUS may be transmitted within the DRX ON duration, or on which beams or when the beams will be transmitted, thus providing the network some flexibility on when and on what beam to transmit the WUS. The network device also need not indicate the number of beams on which the WUS will be transmitted. The DRX ON duration may be configured or pre-defined. As an example, FIG. 7 shows a timeline 700 for transmitting/receiving a WUS 702 during a DRX ON duration 704 associated with a periodicity 706 and an offset 708 from the start of a period defined by the periodicity 706. By way of example, a network device may transmit the WUS 702 on different Tx beams, at the same or different times, within each DRX ON duration 704.

In some cases, separate WUS monitoring occasions may be configured or pre-defined for each Tx beam of a network device. The WUS monitoring occasions may be configured or pre-defined such that the network device has some flexibility on when to transmit a WUS in each WUS monitoring occasion. In these cases, a UE may monitor for a WUS on each Tx beam, in each WUS monitoring occasion (and in some cases may be able to detect the WUS on two or beams). However, if the UE knows which beam or beams the UE receives best (e.g., based on measurements of certain signals), the UE may choose to monitor for the WUS on only some Tx beams (e.g., the best N beams), during some WUS monitoring occasions.

When separate WUS monitoring occasions are configured or pre-defined for each Tx beam of a network device, and in some embodiments, the method 200 may include determining a set of timings of a set of multiple WUS monitoring occasions corresponding to a set of multiple Tx beams of a network device. The set of timings may be based at least in part on the periodicity. The set of multiple WUS monitoring occasions may include the WUS monitoring occasion referenced at 202. The method 200 may also include monitoring for the WUS using the WUR during each WUS monitoring occasion of the set of multiple WUS monitoring occasions.

Alternatively, the method 200 may include monitoring for the WUS using the WUR during a subset of the WUS monitoring occasions. In some embodiments, the method 200 may include transitioning the WUR to the sleep state between temporally sequential WUS monitoring occasions of the set of multiple WUS monitoring occasions.

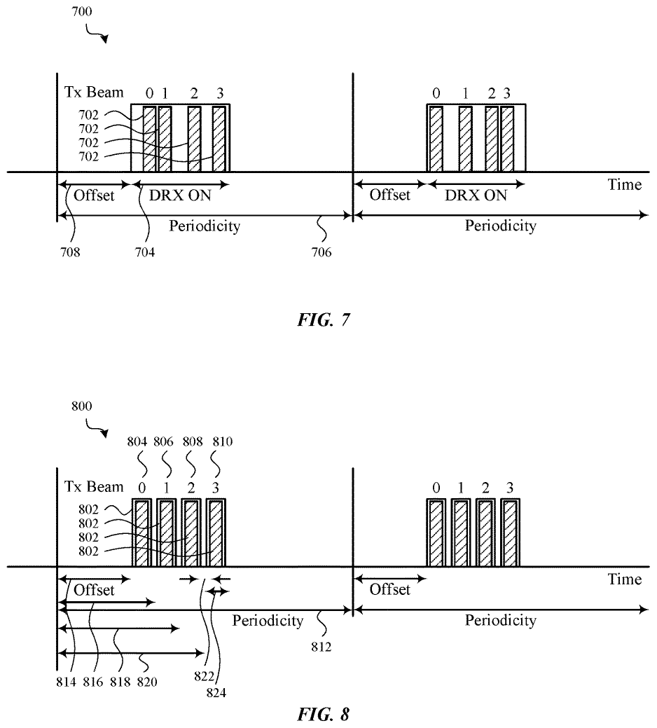

When separate WUS monitoring occasions are configured or pre-defined for each Tx beam of a network device, and in some embodiments, the method 200 may include determining a set of offsets for the WUS monitoring occasions of the set of multiple WUS monitoring occasions (e.g., for different Tx beams). Each offset of the set of offsets may be based on the timing reference or the periodicity referenced at 202. The method 200 may further include determining one or more durations of the WUS monitoring occasions of the set of multiple WUS monitoring occasions, and further determining the set of timings of the set of multiple WUS monitoring occasions based at least in part on the set of offsets for the WUS monitoring occasions and the one or more durations of the WUS monitoring occasions. As an example, FIG. 8 shows a timeline 800 for transmitting/receiving a WUS 802 on one or more of a set of WUS monitoring occasions 804, 806, 808, 810 for a set of Tx beams of a network device. The set of WUS monitoring occasions 804, 806, 808, 810 may be associated with a periodicity 812, an offset 814, 816, 818, 820 (per WUS monitoring occasion 804, 806, 808, 810) from the start of a period defined by the periodicity 812, and a duration 822 of the WUS monitoring occasions 804, 806, 808, 810. The duration(s) of different WUS monitoring occasions 804, 806, 808, 810 may be the same (as shown) or different.

When separate WUS monitoring occasions are configured or pre-defined for each Tx beam of a network device, and in some embodiments, the method 200 may include determining one or more durations of the WUS monitoring occasions of the set of multiple WUS monitoring occasions (e.g., for different Tx beams). The method 200 may also include determining one or more timing gaps between temporally sequential WUS monitoring occasions of the set of multiple WUS monitoring occasions, and further determining the set of timings of the set of multiple WUS monitoring occasions based at least in part on the one or more durations of the WUS monitoring occasions and the one or more timing gaps between temporally sequential WUS monitoring occasions. As an example, WUS monitoring occasion durations 822, and timing gaps 824 between different pairs of temporally sequential (or adjacent) WUS monitoring occasions, are shown in FIG. 8. The WUS monitoring occasion durations 822 for different WUS monitoring occasions 804, 806, 808, 810, and/or the timing gaps 824 between different pairs of temporally sequential WUS monitoring occasions, may be the same (as shown) or different. One advantage of determining a set of timings of a set of WUS monitoring occasions corresponding to multiple beams is that it may allow a UE to map Tx beams to SSB beams.

When separate WUS monitoring occasions are configured or pre-defined for each Tx beam of a network device, and in some embodiments, the method 200 may include identifying a DRX ON duration; determining a number of beams in the set of beams; and determining a duration of each WUS monitoring occasion of the set of multiple WUS monitoring occasions by segmenting the DRX ON duration based at least in part on the number of beams. In some cases, the DRX ON duration may be segmented into WUS monitoring occasions of equal duration. In some cases, the DRX ON duration may not be segmented into WUS monitoring occasions of equal duration (e.g., because a number of slots or symbols is not divisible by the number of Tx beams), and the UE may employ one or more configured or pre-defined rounding rules to segment the DRX ON duration into WUS monitoring occasions having two or more different durations.

In some embodiments of the method 200, and depending on UE implementation, the UE may monitor for a WUS, or maintain its WUR in an awake state, at times outside one or more WUS monitoring occasions. For example, the UE may monitor for a WUS or maintain its WUR in an awake state between WUS monitoring occasions.

In some embodiments of the method 200, separate WUS monitoring occasions may be configured or pre-defined for each Tx beam of a network device, and the WUS monitoring occasions may take the form of WUS transmission start times. That is, instead of identifying a window of time in which the WUS may be transmitted and giving a network device flexibility to transmit the WUS within the window, the WUS may be transmitted on a Tx beam at a particular WUS transmission start time. While offering less flexibility for the network device, this may enable the UE to wake up its WUR for a shorter period of time, thereby enabling the UE to conserve more power. In these embodiments, the method 200 may include determining a set of WUS transmission start times corresponding to a set of multiple Tx beams of a network device. The set of WUS transmission start times may be based at least in part on the periodicity, and the set of WUS transmission start times may include the WUS transmission start time determined at 202. The method 200 may also include monitoring for the WUS at 204, using the WUR, beginning at each WUS transmission start time of the set of WUS transmission start times. Alternatively, the method 200 may include monitoring for the WUS using the WUR during a subset of the WUS transmission start time (e.g., during a subset of WUS transmission start times corresponding to N best beams). In some embodiments, the method 200 may include transitioning the WUR to the sleep state between temporally sequential WUS transmission start times of the set of WUS transmission start times.

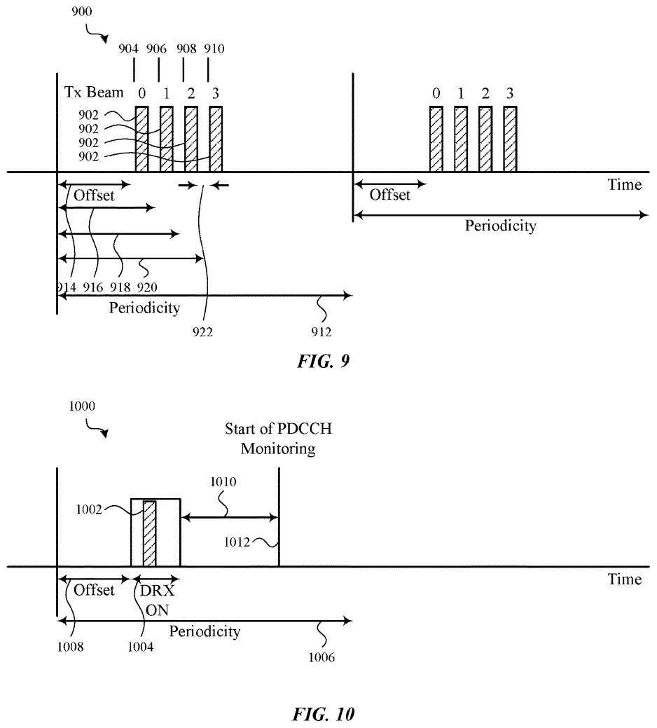

When separate WUS transmission start times are configured or pre-defined for each Tx beam of a network device, and in some embodiments, the method 200 may include determining a set of offsets for the WUS transmission start times of the set of WUS transmission start times (e.g., for different Tx beams). Each offset of the set of offsets may be based on the timing reference or the periodicity referenced at 202. The method 200 may further determine the WUS transmission start times of the set of WUS transmission start times based at least in part on the set of offsets for the WUS transmission start times. As an example, FIG. 9 shows a timeline 900 for transmitting/receiving a WUS 902 at one or more of a set of WUS transmission start times 904, 906, 908, 910 for a set of Tx beams of a network device. The set of WUS transmission start times 904, 906, 908, 910 may be associated with a periodicity 912, and an offset 914, 916, 918, 920 (per WUS transmission start time 904, 906, 908, 910) from the start of a period defined by the periodicity 912.

When separate WUS transmission start times are configured or pre-defined for each Tx beam of a network device, and in some embodiments, the method 200 may include determining one or more timing gaps 1) between temporally sequential WUS transmission start times of the set of WUS transmission start times (e.g., for different Tx beams), or 2) between temporally sequential WUS transmissions (e.g., for different Tx beams), and further determining the set of timings of the set of WUS transmission start times based at least in part on the one or more timing gaps. As an example, WUS transmission start times 922 between different pairs of temporally sequential (or adjacent) WUS transmission start times are shown in FIG. 9. The timing gaps 922 between different pairs of temporally sequential WUS transmission start times may be the same (as shown) or different.

When separate WUS transmission start times are configured or pre-defined for each Tx beam of a network device, and in some embodiments, the method 200 may include determining the set of WUS transmission start times based at least in part on an indicated slot, symbol, or combination of slot and symbol for each WUS transmission start time. That is, a specific WUS transmission start time may be configured or pre-defined for each Tx beam. In some cases, this can provide greater flexibility for a network device to configure WUS transmission start times, and allows for uneven gaps between the WUS transmission start times for different Tx beams. It can also make it easier for WUS transmission start times to be anchored to slot and/or symbol structures.

When separate WUS transmission start times are configured or pre-defined for each Tx beam of a network device, and in some embodiments, the method 200 may include determining the set of WUS transmission start times with reference to a beam transmission pattern per slot. In some embodiments, the beam transmission pattern may repeat in different slots to define the WUS transmission start times for all beams. For example, a 14-bit bitmap may be used to indicate one or more WUS transmission start times for one or more Tx beams of a network device. As an example, the beam transmission pattern [10010010010000] may be configured or pre-defined to mean that Tx beams 0/1/2/3 have WUS transmission start times at symbols 0/3/6/9, respectively. As another example, the beam transmission pattern [10000001000000] may be configured or pre-defined to mean that Tx beams 0/1 have WUS transmission start times at symbols 0/7, respectively, of a first slot, and Tx beams 2/3 have WUS transmission start times at symbols 0/7, respectively, of a second slot.

After detecting the WUS and transitioning the transceiver from the sleep state to the awake state, at 206, the method 200 may include monitoring for paging information. Ideally, the UE and a network through which paging information will be transmitted will have an understanding regarding when, after transmission of a WUS, the paging information will be transmitted by a network device. In this regard, the method 200 may include transmitting, via the transceiver and before the UE enters an RRC idle mode state or RRC inactive mode state, at least one capability pertaining to a time to transition the transceiver from the sleep state to the awake state and monitor for paging information (e.g., a time to transition the transceiver from the sleep state to the awake state, and for the UE to be ready to decode a paging PDCCH). In some embodiments, the at least one capability may account for the time the UE needs to prepare its hardware and achieve sufficient synchronization for the purpose of receiving paging information. In some embodiments, the at least one capability may include a capability for each of at least two different sleep states of the transceiver (e.g., for a low power sleep state and a deep sleep (or OFF) state, respectively).

In some embodiments, the method 200 may include receiving an offset for PDCCH monitoring. The offset for PDCCH monitoring may be anchored to a second timing reference (e.g., the beginning of a WUS monitoring occasion; a WUS transmission start time; the end of a WUS monitoring occasion; the end of a WUS transmission; an end of a DRX ON duration; the start or the end of a last WUS monitoring occasion of a set of WUS monitoring occasions; or the start or the end of a last WUS transmission start time of a set WUS transmissions). As an example, FIG. 10 shows a timeline 1000 for transmitting/receiving a WUS 1002 during a DRX ON duration 1004 associated with a periodicity 1006 and an offset 1008 from the start of a period defined by the periodicity 1006. FIG. 10 also shows an offset 1010 for PDCCH monitoring which is anchored to a timing reference that is the end of the DRX ON duration 1004. The UE is assumed to be ready to monitor PDCCH at time 1012.

The offset for PDCCH monitoring may be configured or pre-defined. When configured, and in some embodiments, the offset for PDCCH monitoring may be received via the transceiver before the UE enters an RRC idle mode state or RRC inactive mode state. The offset for PDCCH monitoring may indicate when the UE should begin monitoring paging PDCCH after waking up the transceiver (following receipt of the WUS). When configured, the offset for PDCCH monitoring may be configured, by a network device, based at least in part on a capability received from the UE (e.g., a capability pertaining to a time to transition the transceiver from the sleep state to the awake state and monitor for paging information).

If the UE reports two or more capabilities pertaining to a time to transition the transceiver from the sleep state to the awake state and monitor for paging information, the offset for PDCCH monitoring may be configured or pre-defined, or the UE may choose and report the offset for PDCCH monitoring (e.g., as a capability). As an example, the network may configure a single offset for PDCCH monitoring, and the UE may always choose (and in some cases report) the capability that supports a wake-up of the transceiver that is smaller than the offset. As another example, the network may configure multiple offsets for PDCCH monitoring, and the UE may choose (and in some cases report) the capability that supports a shortest (or longest) wake-up time for the transceiver that is smaller than at least one of the configured offsets for PDCCH monitoring (or the network may further configure whether to use the shortest or longest wake-up time for the transceiver).

The search space set (SSS) for paging PDCCH monitoring after waking up the transceiver in response to detecting the WUS may be 1) a paging SSS used regardless of waking up the transceiver in response to detecting the WUS, or 2) a separate SSS.

After transitioning the transceiver from the sleep state to the awake state following a detection of the WUS, the method 200 may include monitoring all monitoring occasions in a SSS for paging information (e.g., a paging PDCCH). In some embodiments, the monitoring may be limited to a monitoring window (e.g., a PDCCH monitoring window, or a time window having a configured or pre-defined duration). This may apply to both single Tx beam and multiple Tx beam network devices. In a multiple Tx beam scenario, the network device may be expected to transmit paging information (e.g., a paging PDCCH) on all Tx beams. As an example, FIG. 11 shows a timeline 1100 for transmitting/receiving a WUS 1102 during a DRX ON duration 1104 associated with a periodicity 1106 and an offset 1108 from the start of a period defined by the periodicity 1106. FIG. 11 also shows an offset 1110 for PDCCH monitoring which is anchored to a timing reference that is the end of the DRX ON duration 1104. The UE is assumed to be ready to monitor PDCCH at time 1112, and the UE may monitor all monitoring occasions, in a SSS for paging information, within a PDCCH monitoring window 1114.

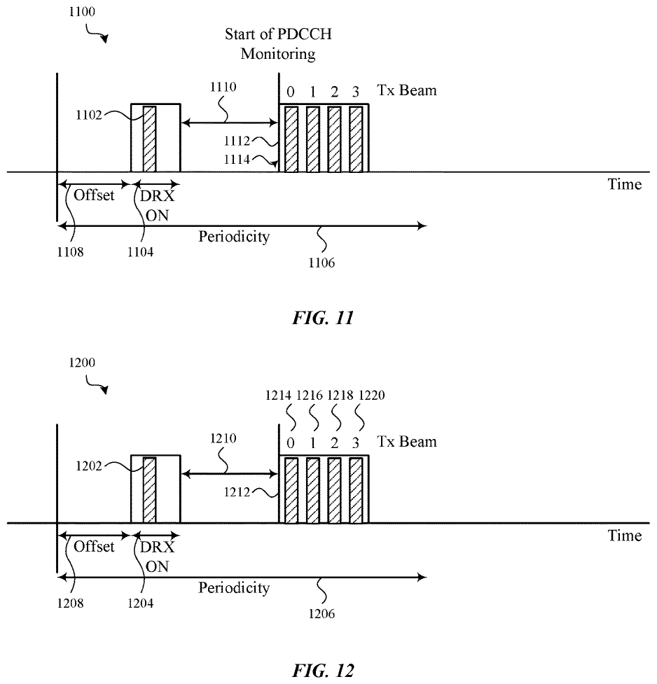

In some embodiments, the monitoring for paging information may be limited to specific monitoring occasions. For a single Tx beam network device, there may be one or multiple monitoring occasions, with the number of monitoring occasions being configured or pre-defined. For a multiple Tx beam network device, and if SSS #0 is reused for the monitoring of paging PDCCH, the specific monitoring occasions may include the monitoring occasions that are mapped to SSB beams, and may be the same as for remaining minimum system information (RMSI) as defined in clause 13 of 3GPP technical specification (TS) 38.213. Alternatively, for a multiple Tx beam network device, and if a SSS other than SSS #0 is used for the monitoring of paging PDCCH, the UE may monitor S*X consecutive PDCCH monitoring occasions (that do not overlap with uplink (UL) symbols according to tdd-UL-DL-ConfigurationCommon), where S is a total number of SSB beams and X is a number of monitoring occasions to monitor for each SSB beam. For example, it can be defined that the (x*S+s)-th PDCCH monitoring occasion (or the (s*X+x)-th PDCCH monitoring occasion), for x=0, . . . , X−1, corresponds to the s-th SSB beam. As an example, FIG. 12 shows a timeline 1200 for transmitting/receiving a WUS 1202 during a DRX ON duration 1204 associated with a periodicity 1206 and an offset 1208 from the start of a period defined by the periodicity 1206. FIG. 12 also shows an offset 1210 for PDCCH monitoring which is anchored to a timing reference that is the end of the DRX ON duration 1204. The UE is assumed to be ready to monitor PDCCH at time 1212, and the UE may monitor specific monitoring occasions 1214, 1216, 1218, and 1220 corresponding to Tx beams 0/1/2/3, respectively.

In some of the embodiments described herein, there is no need for the UE to be aware of the identities of the Tx beam(s) of the network device. In other embodiments, it can be beneficial for the UE to be aware of the identities of the Tx beam(s). For example, if the UE knows the best Tx beam(s) for receiving the WUS, the UE can choose to monitor for the WUS on only the best Tx beam(s), which can reduce the number of times or length of time that a WUR needs to be awake to monitor for the WUS, thus conserving power.

In some embodiments, the method 200 may include receiving assistance signals (e.g., synchronization signals or beacons) on the Tx beams of a network device, and measuring the assistance signals using the WUR. The measurements may then be used to determine the best beam or N best beams.

In some embodiments, the method 200 may include receiving beam information from a network device while the UE is in an active state, and using the beam information while the UE is in an RRC idle mode state or RRC inactive mode state to determine the best beam or N best beams. In some embodiments, the beam information may be flagged as invalid and no longer used when one or more conditions are satisfied. The one or more conditions may include, for example, expiration of a timer, a decrease in reference signal received power (RSRP) that is greater than a threshold, or a camping cell change.

When the UE knows the identities of Tx beams on which a WUS may be received, and the WUS maps to a beam on which an SSB is transmitted, the UE may use the beam information to reduce the number of Tx beams it monitors for an SSB and/or paging PDCCH. For example, the WUS may be transmitted on the beams used for SSB transmission, and there may be a one-to-one correspondence between WUS and SSB transmissions. Alternatively, a beam used for WUS transmission may have a coverage area that maps to multiple beams used for SSB transmission.

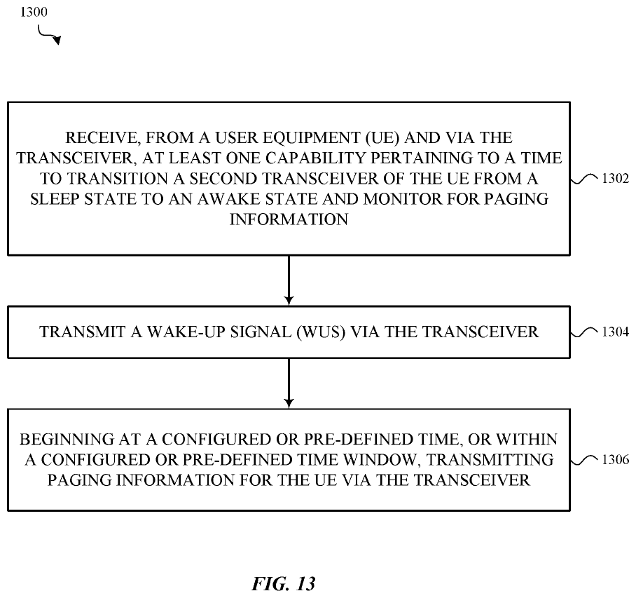

FIG. 13 shows an example method 1300 of wireless communication by a network device (e.g., a network device of a RAN, such as a base station (e.g., a gNB)). In some cases, the network device may be the network device described with reference to FIG. 1 or one of the other network devices described herein. The method 1300 may be performed using a processor, a transceiver, or other components of the network device.

At 1302, the method 1300 may include receiving, from a UE and via the transceiver, at least one capability pertaining to a time to transition a second transceiver of the UE from a sleep state to an awake state and monitor for paging information.

At 1304, the method 1300 may include transmitting a WUS via the transceiver.

At 1306, the method 1300 may include, beginning at a configured or pre-defined time, or within a configured or pre-defined time window, transmitting paging information for the UE via the transceiver.

The method 1300 may be variously embodied, extended, or adapted, as described with reference to FIGS. 2-12 and elsewhere in this description.

Embodiments contemplated herein include one or more non-transitory computer-readable media storing instructions to cause an electronic device, upon execution of the instructions by one or more processors of the electronic device, to perform one or more elements of the method 200 or 1300. In the context of method 200, this non-transitory computer-readable media may be, for example, a memory of a UE (such as a memory 1506 of a wireless device 1502 that is a UE, as described herein). In the context of method 1300, this non-transitory computer-readable media may be, for example, a memory of a network device (such as a memory 1524 of a network device 1520, as described herein).

Embodiments contemplated herein include an apparatus having logic, modules, or circuitry to perform one or more elements of the method 200 or 1300. In the context of method 200, this apparatus may be, for example, an apparatus of a UE (such as a wireless device 1502 that is a UE, as described herein). In the context of method 1300, this apparatus may be, for example, an apparatus of a network device (such as a network device 1520, as described herein).

Embodiments contemplated herein include an apparatus having one or more processors and one or more computer-readable media, using or storing instructions that, when executed by the one or more processors, cause the one or more processors to perform one or more elements of the method 200 or 1300. In the context of method 200, this apparatus may be, for example, an apparatus of a UE (such as a wireless device 1502 that is a UE, as described herein). In the context of the method 1300, this apparatus may be, for example, an apparatus of a network device (such as a network device 1520, as described herein).

Embodiments contemplated herein include a signal as described in or related to one or more elements of the method 200 or 1300.

Embodiments contemplated herein include a computer program or computer program product having instructions, wherein execution of the program by a processor causes the processor to carry out one or more elements of the method 200 or 1300. In the context of method 200, the processor may be a processor of a UE (such as a processor(s) 1504 of a wireless device 1502 that is a UE, as described herein), and the instructions may be, for example, located in the processor and/or on a memory of the UE (such as a memory 1506 of a wireless device 1502 that is a UE, as described herein). In the context of method 1300, the processor may be a processor of a network device (such as a processor(s) 1522 of a network device 1520, as described herein), and the instructions may be, for example, located in the processor and/or on a memory of the network device (such as a memory 1524 of a network device 1520, as described herein).

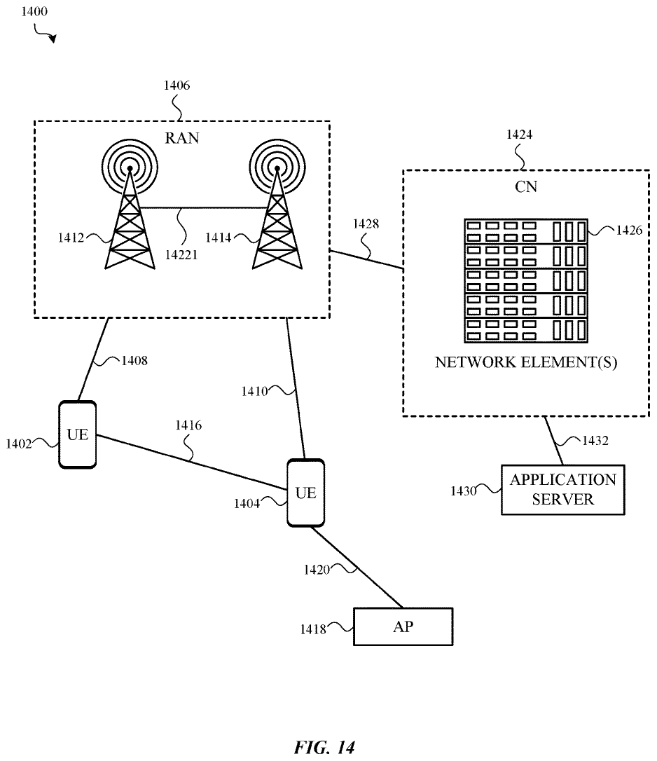

FIG. 14 illustrates an example architecture of a wireless communication system, according to embodiments described herein. The following description is provided for an example wireless communication system 1400 that operates in conjunction with the LTE system standards or specifications and/or 5G or NR system standards or specifications, as provided by 3GPP technical specifications.

As shown by FIG. 14, the wireless communication system 1400 includes UE 1402 and UE 1404 (although any number of UEs may be used). In this example, the UE 1402 and the UE 1404 are illustrated as smartphones (e.g., handheld touchscreen mobile computing devices connectable to one or more cellular networks), but may also comprise any mobile or non-mobile computing device configured for wireless communication.

The UE 1402 and UE 1404 may be configured to communicatively couple with a RAN 1406. In embodiments, the RAN 1406 may be NG-RAN, E-UTRAN, etc. The UE 1402 and UE 1404 utilize connections (or channels) (shown as connection 1408 and connection 1410, respectively) with the RAN 1406, each of which comprises a physical communications interface. The RAN 1406 can include one or more network devices, such as base station 1412 and base station 1414, that enable the connection 1408 and connection 1410.

In this example, the connection 1408 and connection 1410 are air interfaces to enable such communicative coupling, and may be consistent with RAT(s) used by the RAN 1406, such as, for example, an LTE and/or NR.

In some embodiments, the UE 1402 and UE 1404 may also directly exchange communication data via a sidelink interface 1416. The UE 1404 is shown to be configured to access an access point (shown as AP 1418) via connection 1420. By way of example, the connection 1420 can comprise a local wireless connection, such as a connection consistent with any IEEE 802.11 protocol, wherein the AP 1418 may comprise a Wi-Fi® router. In this example, the AP 1418 may be connected to another network (for example, the Internet) without going through a CN 1424.

In embodiments, the UE 1402 and UE 1404 can be configured to communicate using orthogonal frequency division multiplexing (OFDM) communication signals with each other or with the base station 1412 and/or the base station 1414 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1412 or base station 1414 may be implemented as one or more software entities running on server computers as part of a virtual network. In addition, or in other embodiments, the base station 1412 or base station 1414 may be configured to communicate with one another via interface 1422. In embodiments where the wireless communication system 1400 is an LTE system (e.g., when the CN 1424 is an EPC), the interface 1422 may be an X2 interface. The X2 interface may be defined between two or more network devices of a RAN (e.g., two or more eNBs and the like) that connect to an EPC, and/or between two eNBs connecting to the EPC. In embodiments where the wireless communication system 1400 is an NR system (e.g., when CN 1424 is a 5GC), the interface 1422 may be an Xn interface. The Xn interface is defined between two or more network devices of a RAN (e.g., two or more gNBs and the like) that connect to the 5GC, between a base station 1412 (e.g., a gNB) connecting to the 5GC and an eNB, and/or between two eNBs connecting to the 5GC (e.g., CN 1424).

The RAN 1406 is shown to be communicatively coupled to the CN 1424. The CN 1424 may comprise one or more network elements 1426, which are configured to offer various data and telecommunications services to customers/subscribers (e.g., users of UE 1402 and UE 1404) who are connected to the CN 1424 via the RAN 1406. The components of the CN 1424 may be implemented in one physical device or separate physical devices including components to read and execute instructions from a machine-readable or computer-readable medium (e.g., a non-transitory machine-readable storage medium).

In embodiments, the CN 1424 may be an EPC, and the RAN 1406 may be connected with the CN 1424 via an S1 interface 1428. In embodiments, the S1 interface 1428 may be split into two parts, an S1 user plane (S1-U) interface, which carries traffic data between the base station 1412 or base station 1414 and a serving gateway (S-GW), and the S1-MME interface, which is a signaling interface between the base station 1412 or base station 1414 and mobility management entities (MMEs).

In embodiments, the CN 1424 may be a 5GC, and the RAN 1406 may be connected with the CN 1424 via an NG interface 1428. In embodiments, the NG interface 1428 may be split into two parts, an NG user plane (NG-U) interface, which carries traffic data between the base station 1412 or base station 1414 and a user plane function (UPF), and the S1 control plane (NG-C) interface, which is a signaling interface between the base station 1412 or base station 1414 and access and mobility management functions (AMFs).

Generally, an application server 1430 may be an element offering applications that use internet protocol (IP) bearer resources with the CN 1424 (e.g., packet switched data services). The application server 1430 can also be configured to support one or more communication services (e.g., VoIP sessions, group communication sessions, etc.) for the UE 1402 and UE 1404 via the CN 1424. The application server 1430 may communicate with the CN 1424 through an IP communications interface 1432.

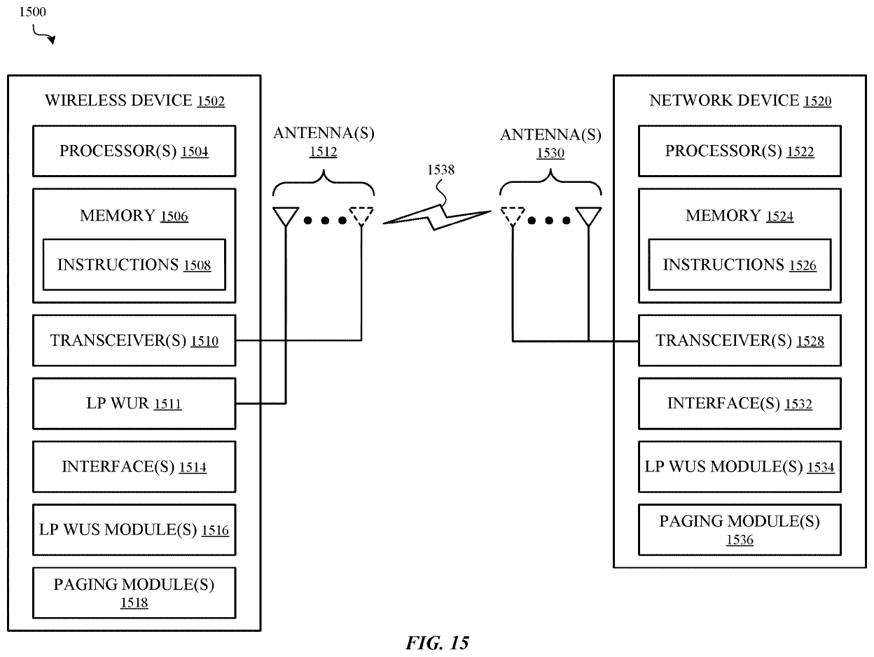

FIG. 15 illustrates an example system 1500 for performing signaling 1538 between a wireless device 1502 and a network device 1520, according to embodiments described herein. The system 1500 may be a portion of a wireless communication system as herein described. The wireless device 1502 may be, for example, a UE of a wireless communication system. The network device 1520 may be, for example, a base station (e.g., an eNB or a gNB) or a radio head of a wireless communication system.

The wireless device 1502 may include one or more processor(s) 1504. The processor(s) 1504 may execute instructions such that various operations of the wireless device 1502 are performed, as described herein. The processor(s) 1504 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1502 may include a memory 1506. The memory 1506 may be a non-transitory computer-readable storage medium that stores instructions 1508 (which may include, for example, the instructions being executed by the processor(s) 1504). The instructions 1508 may also be referred to as program code or a computer program. The memory 1506 may also store data used by, and results computed by, the processor(s) 1504.

The wireless device 1502 may include one or more transceiver(s) 1510 (also collectively referred to as a transceiver 1510) that may include radio frequency (RF) transmitter and/or receiver circuitry that use the antenna(s) 1512 of the wireless device 1502 to facilitate signaling (e.g., the signaling 1538) to and/or from the wireless device 1502 with other devices (e.g., the network device 1520) according to corresponding RATs. The wireless device 1502 may also include a WUR (e.g., a LP-WUR) 1511 that enables the wireless device 1502 to detect and/or measure, using the antenna(s) 1512, a LP-WUS received from one or more other devices.

The wireless device 1502 may include one or more antenna(s) 1512 (e.g., one, two, four, eight, or more). For embodiments with multiple antenna(s) 1512, the wireless device 1502 may leverage the spatial diversity of such multiple antenna(s) 1512 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 1502 may be accomplished according to precoding (or digital beamforming) that is applied at the wireless device 1502 that multiplexes the data streams across the antenna(s) 1512 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In some embodiments having multiple antennas, the wireless device 1502 may implement analog beamforming techniques, whereby phases of the signals sent by the antenna(s) 1512 are relatively adjusted such that the (joint) transmission of the antenna(s) 1512 can be directed (this is sometimes referred to as beam steering).

The wireless device 1502 may include one or more interface(s) 1514. The interface(s) 1514 may be used to provide input to or output from the wireless device 1502. For example, a wireless device 1502 that is a UE may include interface(s) 1514 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1510/antenna(s) 1512 already described) that allow for communication between the UE and other devices and may operate according to known protocols (e.g., Wi-Fi®, Bluetooth®, and the like).

The wireless device 1502 may include LP WUS module(s) 1516 and paging module(s) 1518. The LP WUS module(s) 1516 and paging module(s) 1518 may be implemented via hardware, software, or combinations thereof. For example, the LP WUS module(s) 1516 and paging module(s) 1518 may be implemented as a processor, circuit, and/or instructions 1508 stored in the memory 1506 and executed by the processor(s) 1504. In some examples, the LP WUS module(s) 1516 and paging module(s) 1518 may be integrated within the processor(s) 1504 and/or the transceiver(s) 1510. For example, the LP WUS module(s) 1516 and paging module(s) 1518 may be implemented by a combination of software components (e.g., executed by a DSP or a general processor) and hardware components (e.g., logic gates and circuitry) within the processor(s) 1504 or the transceiver(s) 1510.

The LP WUS module(s) 1516 may be used for various aspects of the present disclosure, for example, aspects of FIGS. 1-13, from a wireless device or UE perspective. The LP WUS module(s) 1516 may use, for example, to monitor for and detect a WUS on one or more Tx beams of a network device, such as the network device 1520. The paging module(s) 1518 may be used, for example, to monitor for and respond to paging information received from a network device, such as the network device 1520.

The network device 1520 may include one or more processor(s) 1522. The processor(s) 1522 may execute instructions such that various operations of the network device 1520 are performed, as described herein. The processor(s) 1522 may include one or more baseband processors implemented using, for example, a CPU, a DSP, an ASIC, a controller, an FPGA device, another hardware device, a firmware device, or any combination thereof configured to perform the operations described herein.

The network device 1520 may include a memory 1524. The memory 1524 may be a non-transitory computer-readable storage medium that stores instructions 1526 (which may include, for example, the instructions being executed by the processor(s) 1522). The instructions 1526 may also be referred to as program code or a computer program. The memory 1524 may also store data used by, and results computed by, the processor(s) 1522.

The network device 1520 may include one or more transceiver(s) 1528 (also collectively referred to as a transceiver 1528) that may include RF transmitter and/or receiver circuitry that use the antenna(s) 1530 of the network device 1520 to facilitate signaling (e.g., the signaling 1538) to and/or from the network device 1520 with other devices (e.g., the wireless device 1502) according to corresponding RATs.

The network device 1520 may include one or more antenna(s) 1530 (e.g., one, two, four, or more). In embodiments having multiple antenna(s) 1530, the network device 1520 may perform MIMO, digital beamforming, analog beamforming, beam steering, etc., as has been described.

The network device 1520 may include one or more interface(s) 1532. The interface(s) 1532 may be used to provide input to or output from the network device 1520. For example, a network device 1520 of a RAN (e.g., a base station, a radio head, etc.) may include interface(s) 1532 made up of transmitters, receivers, and other circuitry (e.g., other than the transceiver(s) 1528/antenna(s) 1530 already described) that enables the network device 1520 to communicate with other equipment in a network, and/or that enables the network device 1520 to communicate with external networks, computers, databases, and the like for purposes of operations, administration, and maintenance of the network device 1520 or other equipment operably connected thereto.

The network device 1520 may include one or more LP WUS module(s) 1534 and paging module(s) 1536. The LP WUS configuration module(s) 1534 and paging module(s) 1536 may be implemented via hardware, software, or combinations thereof. For example, the LP WUS module(s) 1534 and paging module(s) 1536 may be implemented as a processor, circuit, and/or instructions 1526 stored in the memory 1524 and executed by the processor(s) 1522. In some examples, the LP WUS module(s) 1534 and paging module(s) 1536 may be integrated within the processor(s) 1522 and/or the transceiver(s) 1528. For example, the LP WUS module(s) 1534 and paging module(s) 1536 may be implemented by a combination of software components (e.g., executed by a DSP or a general processor) and hardware components (e.g., logic gates and circuitry) within the processor(s) 1522 or the transceiver(s) 1528.

The LP WUS module(s) 1534 may be used for various aspects of the present disclosure, for example, aspects of FIGS. 1-13, from a network device perspective. The LP WUS module(s) 1534 may be used, for example, to configure and transmit a LP WUS on one or more Tx beams. The paging module(s) 1536 may be used, for example, to page a wireless device, such as the wireless device 1502.

For one or more embodiments, at least one of the components set forth in one or more of the preceding figures may be configured to perform one or more operations, techniques, processes, and/or methods as set forth herein. For example, a baseband processor (or processor) as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form described.

Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus comprising memory coupled to a processor, the processor configured to:
determine a timing of a wake-up signal (WUS) monitoring occasion, the timing based at least in part on a periodicity anchored to a timing reference, and on an offset based on the timing reference or the periodicity;
monitor for a WUS, via a wake-up receiver (WUR) of a user equipment (UE), during the WUS monitoring occasion; and
transition a transceiver of the UE from a sleep state to an awake state upon detecting the WUS during the WUS monitoring occasion.

2. The apparatus of claim 1, wherein:
the processor is configured to:
determine a number of multiple WUS monitoring occasions in a set of multiple WUS monitoring occasions, the set of multiple WUS monitoring occasions including the WUS monitoring occasion;
determine a timing gap between temporally sequential WUS monitoring occasions of the set of multiple WUS monitoring occasions;
determine a set of timings of the set of multiple WUS monitoring occasions, the set of timings based at least in part on the periodicity, the offset, and the timing gap; and
monitor for the WUS using the WUR during each WUS monitoring occasion of the set of multiple WUS monitoring occasions.

3. The apparatus of claim 2, wherein the processor is configured to transition the WUR to the sleep state between temporally sequential WUS monitoring occasions of the set of multiple WUS monitoring occasions.

4. The apparatus of claim 1, wherein
the processor is configured to:
identify a discontinuous reception (DRX) ON duration; and
determine a duration of the WUS monitoring occasion based at least in part on the DRX ON duration.

5. The UE apparatus of claim 1, wherein
the processor is configured to:
determine a set of timings of a set of multiple WUS monitoring occasions corresponding to a set of multiple transmit (Tx) beams of a network device, the set of timings based at least in part on the periodicity, and the set of multiple WUS monitoring occasions including the WUS monitoring occasion; and
monitor for the WUS using the WUR during each WUS monitoring occasion of the set of multiple WUS monitoring occasions.

6. The apparatus of claim 5, wherein the processor is configured to transition the WUR to the sleep state between temporally sequential WUS monitoring occasions of the set of multiple WUS monitoring occasions.

7. The apparatus of claim 5, wherein
the processor is configured to:
determine a set of offsets for the WUS monitoring occasions of the set of multiple WUS monitoring occasions, each offset of the set of offsets based on the timing reference or the periodicity;
determine one or more durations of the WUS monitoring occasions of the set of multiple WUS monitoring occasions; and
further determine the set of timings of the set of multiple WUS monitoring occasions based at least in part on the set of offsets for the WUS monitoring occasions and the one or more durations of the WUS monitoring occasions.

8. The apparatus of claim 5, wherein
the processor is configured to:
determine one or more durations of the WUS monitoring occasions of the set of multiple WUS monitoring occasions;
determine one or more timing gaps between temporally sequential WUS monitoring occasions of the set of multiple WUS monitoring occasions; and
further determine the set of timings of the set of multiple WUS monitoring occasions based at least in part on the one or more durations of the WUS monitoring occasions and the one or more timing gaps between temporally sequential WUS monitoring occasions.

9. The apparatus of claim 5, wherein
the processor is configured to:
identify a discontinuous reception (DRX) ON duration;
determine a number of beams in the set of multiple Tx beams; and
determine a duration of each WUS monitoring occasion of the set of multiple WUS monitoring occasions by segmenting the DRX ON duration based at least in part on the number of beams.

10. The UE apparatus of claim 1, wherein:
the timing of the WUS monitoring occasion is a WUS transmission start time; and
the processor is configured to,
determine a set of WUS transmission start times corresponding to a set of multiple transmit (Tx) beams of a network device, the set of WUS transmission start times based at least in part on the periodicity, and the set of WUS transmission start times including the WUS transmission start time; and
monitor for the WUS, using the WUR, beginning at each WUS transmission start time of the set of WUS transmission start times.

11. The apparatus of claim 10, wherein
the processor is configured to:
determine a set of offsets for the WUS transmission start times of the set of WUS transmission start times, each offset of the set of offsets based on the timing reference or the periodicity; and
further determine the WUS transmission start times of the set of WUS transmission start times based at least in part on the set of offsets for the WUS transmission start times.

12. The apparatus of claim 10, wherein
the processor is configured to:
determine one or more timing gaps between temporally sequential WUS transmission start times of the set of WUS transmission start times or between temporally sequential WUS transmissions; and
further determine the set of WUS transmission start times based at least in part on the one or more timing gaps.

13. The apparatus of claim 10, wherein the processor is configured to determine the set of WUS transmission start times based at least in part on an indicated slot, symbol, or combination of slot and symbol for each WUS transmission start time.

14. The apparatus of claim 10, wherein the processor is configured to determine the set of WUS transmission start times with reference to a beam transmission pattern per slot.

15. The apparatus of claim 1, wherein the processor is configured to report, at least one capability pertaining to a time to transition the transceiver from the sleep state to the awake state and monitor for paging information.

16. The apparatus of claim 15, wherein the at least one capability comprises a capability for each of at least two different sleep states of the transceiver.

17. The apparatus of claim 1, wherein the processor is configured to receive an offset for physical downlink control channel (PDCCH) monitoring, the offset for PDCCH monitoring anchored to a second timing reference.

18. The apparatus of claim 1, wherein, after transitioning the transceiver from the sleep state to the awake state following detection of the WUS, the processor is configured to monitor all monitoring occasions in a search space set (SSS), within a monitoring window, for paging information.

19. The apparatus of claim 1, wherein, after transitioning the transceiver from the sleep state to the awake state following detection of the WUS, the processor is configured to monitor a set of monitoring occasions in a search space set (SSS) for paging information.

20. An apparatus comprising memory coupled to a baseband processor, the processor configured to:
receive, from a user equipment (UE) at least one capability pertaining to a time to transition a second transceiver of the UE from a sleep state to an awake state and monitor for paging information;
transmit a wake-up signal (WUS); and
beginning at a configured or pre-defined time, or within a configured or pre-defined time window, transmitting paging information for the UE.
